(19) United States
(12) Patent Application Publication
(10) Pub. No.: US 2020/0376725 A1
(43) Pub. Date: Dec. 3, 2020

(54) THERMAL MEMBRANE, VEHICLE INTERIOR PANEL, AND METHOD OF MANUFACTURING A VEHICLE INTERIOR PANEL WITH A THERMAL MEMBRANE

(71) Applicant: Faurecia Interior Systems, Inc., Auburn Hills, MI (US)

(72) Inventor: Ulrich Weissert, Northville, MI (US)

(21) Appl. No.: 16/423,954

(22) Filed: May 28, 2019

(51) Int. Cl. B29C 43/56; B29C 43/52

(52) U.S. Cl. CPC B29C 43/56; B29L 2031/3005; B29C 2791/006; B29C 43/52

(57) ABSTRACT

A thermal membrane for manufacturing a vehicle interior panel. The thermal membrane includes a flexible body, a part contour in the flexible body, and a thermal array that includes a thermal temperature control element. The thermal array follows the part contour of the flexible body, and the thermal temperature control element is at least partially embedded in the flexible body. The thermal array of the thermal membrane can be used to heat and activate an adhesive layer during a method of manufacturing a vehicle interior panel, such as during a vacuum forming process to attach a skin layer to a substrate.

### TECHNICAL FIELD

The invention relates to membranes used in forming operations and methods of manufacturing vehicle interior panels using membranes.

### BACKGROUND

Many vehicle interior panels include a skin layer and a substrate, sometimes with one or more interlayers. A vacuum forming method, in which the multi-layer panel is sandwiched between a flexible membrane and a vacuum fixture, can be employed to help adhere the skin or covering layer on the substrate and/or an interlayer. During such a method, activation of one or more adhesive layers between the substrate, interlayer, and/or skin layer may be required. Oftentimes, the adhesive layers need to be heated to a sufficient activation temperature. Typically, an oven or a separate heater is used for heating the adhesive layers to the activation temperature. One example of this is described in EP 2 065 153 to Uguccioni et al. However, use of an oven or a separate heater can involve an extra manufacturing step that could increase cycle time and require increased energy usage.

In other implementations, such as those described in DE 103 40 856 to Schorer, US 2006/0038320 to Straub et al., and U.S. Pat. No. 7,837,911 to Bristow et al., heating elements are included in the rigid mold devices themselves. However, in such implementations, the heating elements may be more remote from the part and the adhesive layers, which could also increase cycle time. The temperature control may also be more difficult given the heat conductivity of the mold device and the remoteness of the heating elements from the part. Additionally, when the heating elements are statically implemented in a more rigid structure, they may not conform as well to the various intricacies and features of the part. This could further impact adhesive activation.

### SUMMARY

In accordance with an embodiment, there is provided a thermal membrane comprising a flexible body; a part contour in the flexible body; and a thermal array that includes a thermal temperature control element, wherein the thermal array follows the part contour of the flexible body and the thermal temperature control element is at least partially embedded in the flexible body.

In some embodiments, the part contour has a stabilized form that maintains a three-dimensional shape when the thermal membrane is isolated.

In some embodiments, the three-dimensional shape is a membrane shoulder configured to conform to a part shoulder of an interior panel of a vehicle.

In some embodiments, the thermal temperature control element at least partially follows the membrane shoulder.

In sonic embodiments, the flexible body is made from a silicone-based material or a rubber-based material.

In some embodiments, a temperature of the thermal temperature control element is configured to exceed an adhesive activation temperature.

In some embodiments, the thermal temperature control element is a heating wire.

In some embodiments, the heating wire is arranged in a serpentine shape that includes a plurality of undulations, each undulation having a peak.

In some embodiments, each peak is situated outside of an interior part portion of the flexible body.

In some embodiments, there is provided an interior panel for a vehicle comprising a substrate; a skin layer; an adhesive layer, wherein the adhesive layer is activated by the thermal array of the thermal membrane.

In some embodiments, the skin layer defines an A-side of the vehicle interior panel, and the flexible body of the heating membrane has a shape that conforms to a shape of the A-side.

In some embodiments, the adhesive layer is a compound adhesive layer comprising adhesive material from an outboard surface of the skin layer and an inboard surface of an interlayer.

In accordance with another embodiment, there is provided a method of manufacturing an interior panel for a vehicle, the interior panel having a multi-layer structure with a skin layer, a substrate, an interlayer between the skin layer and the substrate, and an adhesive layer adjacent the interlayer. The method comprises the steps of: applying the adhesive layer to the interlayer, to the skin layer, or to both the interlayer and the skin layer; situating a thermal membrane over the multi-layer structure, wherein the thermal membrane comprises a flexible body and a thermal temperature control element that is at least partially embedded in the flexible body; and heating the thermal temperature control element in the thermal membrane.

In some embodiments, the method further comprises the step of situating the multi-layer structure over a vacuum fixture, and the heating step takes place while the multi-layer structure is being vacuumed by the vacuum fixture.

In some embodiments, the method further comprises the step of activating an adhesive material in the adhesive layer by heating the thermal temperature control element to a temperature above an adhesive activation temperature.

Various aspects, embodiments, examples, features and alternatives set forth in the preceding paragraphs, in the claims, and/or in the following description and drawings may be taken independently or in any combination thereof. For example, features disclosed in connection with one embodiment are applicable to all embodiments in the absence of incompatibility of features.

### DESCRIPTION OF THE DRAWINGS

One or more embodiments will hereinafter he described in conjunction with the appended drawings, wherein like designations denote like elements, and wherein:

FIG. 1 is a perspective view of a thermal membrane situated over a vehicle interior panel and a vacuum fixture, in accordance with one embodiment; and

FIG. 2 is a cross-section view of the thermal membrane, panel, and vacuum fixture of FIG. 1, taken at line 2-2 in FIG. 1.

### DETAILED DESCRIPTION OF EMBODIMENTS)

Described below is a thermal membrane that can be used to manufacture interior panels for vehicles. With certain forming processes, such as vacuum forming with a vacuum fixture, it can be helpful to include a membrane, oftentimes made of silicone or another flexible material, over the fixture and the part to be formed. When the part is a multi-layer structure, oftentimes adhesive layers will be included between one or more of the various layers. In some embodiments, the thermal membrane has an integrated thermal. temperature control element that can be used to heat the adhesive layer to an adhesive activation temperature. This temperature adjustment can occur during the vacuum process, which can be more efficient from a manufacturing standpoint. For example, cycle times may decrease, energy usage may be more conservative, etc. Additionally, the thermal membrane can allow the part to cool while the vacuum is applied. Heating and/or cooling the part while the vacuum is applied can help prevent potential delamination of a multi-layer structure.

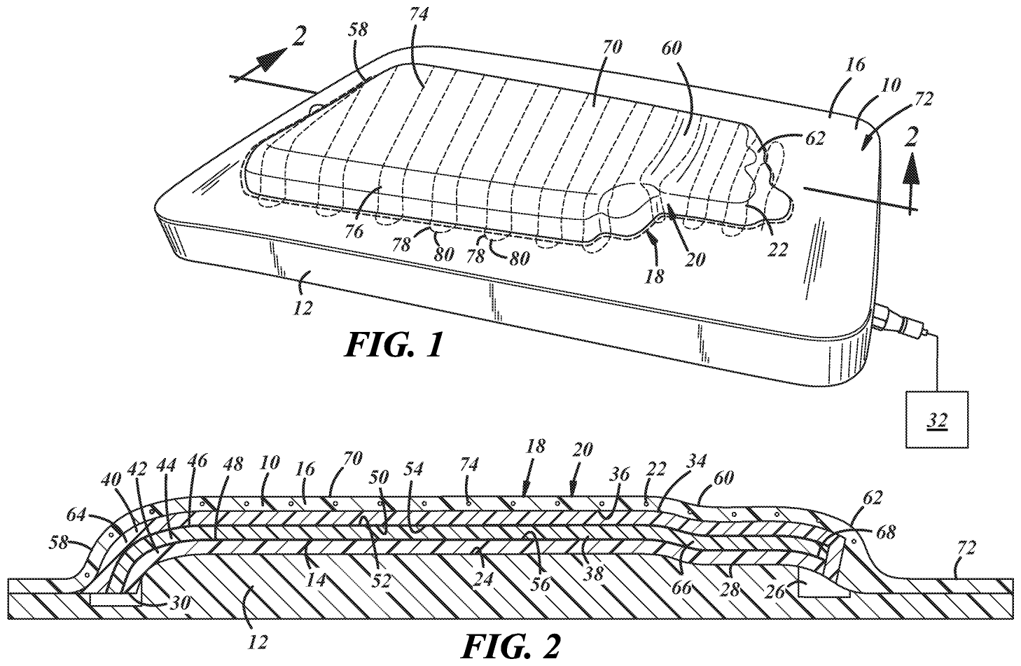

FIGS. 1 and 2 show a thermal membrane 10 that is draped over a vacuum fixture 12. FIG. 1 is a perspective view of the thermal membrane 10 situated atop of the vacuum fixture 12, and FIG. 2 is a cross-section view of the thermal membrane 10 and the vacuum fixture 12, taken along line 2-2 in FIG. 1. The thermal membrane 10 is described herein within the context of the vacuum-based manufacture of a vehicle interior panel 14, as shown in FIG. 2, in which the panel 14 is sandwiched between the thermal membrane 10 and the vacuum fixture 12. However, the thermal membrane 10 can certainly be used with other manufacturing processes, forming operations, etc., as the vacuum-based implementation described herein is only an example. Further, structural variations to the part or panel 14, beyond what is illustrated in the figures and described particularly herein, are also possible as well.

In the illustrated embodiment, the thermal membrane 10 assists in the manufacture of the vehicle interior panel 14. The thermal membrane 10 comprises a flexible body 16 having an interior part portion 18. A thermal array 20 is located within the interior part portion 18. The thermal array 20 includes a thermal temperature control element 22, which in this embodiment, includes a heating wire embedded within the flexible body 16. The thermal temperature control element 22 can be used to heat and/or cool the vehicle interior panel 14 during a forming process, such as vacuum forming.

The vacuum fixture 12 includes a contoured outer surface 24 having a vacuum channel 26. In this particular embodiment, the contoured outer surface 24 is shaped to mimic the shape of the B-side 28 of the vehicle interior panel 14, with the vacuum channel 26 being configured to generally follow an outer perimeter 30 of the panel 14. A vacuum source or vacuum pump 32 creates a negative pressure in the vacuum channel 26 to encourage adhesion of the various layers of the vehicle interior panel 14. Again, while the present description is recited in the context of a vacuum forming process, the thermal membrane 10 could be used in a multitude of different forming processes, particularly any that involve bonding with heat and pressure.

In the figures, the thermal membrane 10 is situated over the vacuum fixture 12, with the vehicle interior panel 14 sandwiched therebetween. The vehicle interior panel 14 may be any type of panel having a visible outer side or A-side 34 exposed to the interior of a vehicle passenger cabin when installed in the vehicle, such as an instrument panel, door panel, console lid, arm rest, pillar cover, steering wheel panel, seat covering, etc. During manufacture of the vehicle interior panel 14, the A-side 34 directly faces a contact side 36 of the thermal membrane 10, and the B-side 28 directly faces the contoured outer surface 24. When the manufactured panel 14 is installed in a vehicle, the B-side 28 faces away from the interior cabin of the vehicle. Having the A-side 34 directly face and contact the contact side 36 of the thermal membrane 10 can be advantageous, as will be detailed further below. More direct heat transfer between the vehicle interior panel 14 and the thermal membrane 10 can result in a component with a multi-layer structure 38 that may be less prone to delamination.

The vehicle interior panel 14 includes a multi-layer structure 38 that is comprised of multiple layers of different materials that provide various, structural, functional, aesthetic, and/or tactile qualities. Depending on the implementation, the multi-layer structure 38 can include a skin layer 40 and a substrate 42. Other interlayers may be included, such as a spacer 44 and one or more adhesive layers 46, 48. There may be more layers than what is illustrated in FIG. 2, or there could be less layers. Further, the layers may be different in configuration and/or composition from what is illustrated and described herein, as the multi-layer structure 38 described below is merely an example. In an advantageous embodiment, the multi-layer structure 38 is used with a cut and sew premium wrapped panel 14. However, other implementations are certainly possible.

The skin layer 40 is the outermost layer of the panel 14 and includes the visible outer side or A-side 34 of the panel with an opposite side facing outboard toward the substrate 42. The primary function of the skin layer 40 is to provide a resilient, long-lasting exposed surface within the vehicle with aesthetic appeal to occupants of the passenger cabin, including desirable visual characteristics such as color, shape, and texture. The skin layer 40 may thus include design features visible at the outer side or A-side 34, such as an embossed pattern or a paint film in the desired color. The skin layer 40 may also at least partly provide the panel 14 with desired tactile characteristics in the likeness of furniture upholstery, such as a soft-touch or smooth feel. In some cases, the skin layer 40 is formed with synthetic materials configured with aesthetic characteristics imitating other more expensive materials such as leather. In yet other embodiments, the skin layer 40 is a natural material such as leather.

The substrate 42 is typically the most rigid of the illustrated panel layers and thereby provides structural support for the overlying layers at desired locations within the vehicle via attachment to other vehicle structures. Fiberglass-reinforced polypropylene having a thickness of 2 mm to 4 mm is one example of a suitable substrate 42, but various other types of materials and material combinations and/or different thickness ranges can be employed in a similar manner. As shown in FIG. 2, the skin layer 40 may at least partially overlap the outer perimeter 30 of the substrate 42 during manufacture, and if necessary, extra material can be trimmed, or in some embodiments, the skin layer 40 may be sized to more closely conform to an area defined by the outer perimeter 30 of the substrate 42.

The spacer 44 is an interlayer that can assist the skin layer 40 in providing desired tactile characteristics to the panel 14. Such tactile characteristics may be in the form of cushioning that compresses when a force is applied to the outer or A-side 34 of the panel 14 and decompresses when the force is removed to return the skin layer 40 to its original position. In one embodiment, the spacer 44 is fabric layer or scrim layer having a thickness between about 1.5-4 mm, inclusive. In another embodiment, the spacer 44 is a foam layer. One suitable foam layer material is polyurethane foam formed from a liquid precursor material comprising a polyol and a diisocyanate. Other foam materials (e.g., polyolefin-based) are possible. When the spacer 44 or interlayer is a foam layer, it may range in thickness from 1 mm to 10 mm, and it can be separately provided and adhered with adjacent material layers. The spacer 44 can also provide sound deadening and/or have a non-uniform thickness to fill space between the skin layer 40 and the substrate 42 when the respective contours of the skin layer and substrate are different from each other. Additional interlayers may also be included with the spacer 44.

Adhesive layers 46, 48 are interlayers that can be included between the skin layer 40 and the spacer 44, and between the spacer 44 and the substrate 42, respectively. In some embodiments, there may only be one adhesive layer, such as when the panel does not have a spacer, or if only one adhesive layer 46 is included between the skin layer 40 and the spacer 44 (e.g., the adhesive material, in some implementations, may penetrate the spacer material to help adhere the substrate 42). In other embodiments, there could be more adhesive layers than what is shown, depending on the number of base layers. In an advantageous implementation, the adhesive layer 46 is a compound adhesive layer in which adhesive material is applied to both an outboard surface 50 of the skin layer 40 and an inboard surface 52 of the spacer 44 (inboard is used to describe a direction towards the interior passenger cabin when the vehicle interior panel 14 is installed, and outboard is used to describe a direction facing away from the interior passenger cabin when the panel 14 is installed). Similarly, the adhesive layer 48 is a compound adhesive layer in which adhesive material is applied to both an outboard surface 54 of the spacer 44 and an inboard surface 56 of the substrate 42. in this implementation, use of a water-based adhesive is advantageous, as both surfaces surfaces 50, 52 for adhesive layer 46, and surfaces 54, 56 for adhesive layer 48) can be sprayed or otherwise dispersed before the vacuum forming process. This implementation provides a panel 14 with a softer or more cushioned feel. Other adhesive types, adhesive configurations, etc. are possible as well. To cite one example implementation, a hot melt adhesive can be roll-coated or sprayed on one or more surfaces. With hot melt adhesive, it may be more desirable to only coat one side to create the adhesive layer (e.g., a single adhesive layer as opposed to the compound adhesive layer described above)

The adhesive layer 46, 48, whether water-based or hot melt, needs to reach a particular adhesive activation temperature. At the adhesive activation temperature, cross-linking of the adhesive material begins to occur. In accordance with one embodiment, the adhesive activation temperature is about 50-60° C., or more particularly, 55° C. The adhesive activation temperature may depend on a number of factors, including but not limited to, adhesive type, layer thickness, or application method. Unlike previous processes in which the adhesive layer is brought to an activation temperature with a separate heater or oven, the thermal membrane 10 provides for conformal adhesive activation through the use of a thermal array 20 in the flexible body 16 that more directly and robustly heats the adhesive layer or layers 46, 48.

The flexible body 16 makes up the bulk of the thermal membrane 10, and includes a thermal temperature control element 22 at least partially embedded therein to create the thermal array 20. The flexible body 16 includes a number of part contours 58, 60, 62. Each part contour 58, 60, 62 is an elevational change in the interior part portion 18. The part contour 58 is an outer membrane shoulder that is configured to conform to a part shoulder 64 in the panel 14. The part contour 60 is an interior membrane shoulder that conforms to an internal dip or ridge 66 in the panel 14. The part contour 62 is a curved membrane radius that conforms to a curved external part shoulder 68. The part contours 58, 60, 62 generally define the interior part portion 18 of the membrane 10. In this portion 18, the shape of the membrane 10 generally conforms to the shape of the A-side 34 of the vehicle interior panel 14. Each part contour 58, 60, 62 has a stabilized form that maintains its three-dimensional shape when the thermal membrane 10 is isolated. In other words, when the membrane 10 is removed from the vacuum fixture 12, it still maintains elevational changes at the part contours, unlike most membranes that are generally flatter and only partly conform when placed on the panel 14. The part contours 58, 60, 62 add a third-dimensional shape or elevation change which is maintainable even when the flexible body 16 is isolated or pulled taut, which is different than other more typical flexible membranes that do not maintain a more static change in elevation. Adding the elevational changes in the third-dimension can improve the robustness of the process and provide a multi-layer structure 38 that is less likely to delaminate. When the vacuum pump 32 is applied in the vacuum fixture 12, the top surface 70 (e.g., the area interior of the part contour/external membrane shoulder 58 and part shoulder 64) is put under more pressure, which can cause the sidewalk of the shoulder to push outwardly to an extent. The part contours 58, 60, 62 and the three-dimensional shape of the interior part portion 18 help provide better pressure distribution and can help offset the vacuum pressure differences at these various panel elevational changes.

The flexible body 16 maintains its three-dimensional shape, although it is not a rigid structure. In one embodiment, “flexible,” when used to describe the body 16, means that the body is comprised of a silicone-based material or a rubber-based material (either natural or man-made rubber). In one advantageous example, the flexible body 16 comprises numerous layers of silicone, or sprayed or cast silicone, which can be useful when fully embedding the thermal temperature control element 22. In another embodiment, “flexible,” when used to describe the body 16, means that the body has an elongation at break of about 60-1120%. In an advantageous embodiment, the body 16 has an elongation at break of about 700-900%.

The flexible body 16 includes a thermal array 20 in the interior part portion 18.

The thermal array 20 is an area or region in the flexible body 16 that is heated or cooled with respect to its general surroundings (e.g., with respect to an outer perimeter area 72 of the flexible body 16). The thermal array 20 is generally defined by the area in which the thermal temperature control element 22 is provided. In this embodiment, the thermal array 20 extends just beyond the perimeter of the internal part portion 18, but not into the outer perimeter area 72. In some embodiments, the outer perimeter area 72 may be defined as an area between the outer edge and a location corresponding to the vacuum channel 26. It is possible, in some embodiments, for the thermal array 20 to be larger (e.g., the whole extent of the thermal membrane 10) or smaller than what is shown (e.g., if adhesive is only required in a certain area of the part, the size of the thermal array 20 may coincide with the size of the adhesive area). If the multi-layer structure 38 has an adhesive layer along its entire extent, it is advantageous for the thermal array 20 to be at least the same size as the panel 14, or larger.

The thermal temperature control element 22 is used in the illustrated embodiments to bring the adhesive layers 46, 48 to the adhesive activation temperature, as described above. Accordingly, in such an embodiment, the thermal temperature control element 22 is a heating wire 74, a heating element or heat source, etc. In some embodiments, a plurality of heating wires or distinct heaters are used as the thermal temperature control element 22. For example, wire loops or wire mesh could be at least partially embedded in the flexible body 16. The thermal temperature control element 22 could also be a cooling element, or the thermal temperature control element 22 could consist of both heating and cooling elements, or a single device, wire, etc. that is capable of both heating and cooling. For example, the thermal membrane 10 could include some sort of cooling channel or the like in addition to, or in replacement of, the heating wire 74. For electrical thermal temperature control elements 22, such as the heating wire 74, a power source and/or power adapter may be included with the thermal membrane 10.

in an advantageous embodiment, as illustrated in FIG. 1, the thermal temperature control element 22 is situated in a serpentine shape 76 that includes a plurality of undulations 78, each undulation having a peak 80 (only a few of the undulations 78 and peaks 80 are labeled in FIG. 1 for clarity purposes). This arrangement and shape is useful for minimizing hotspots and providing better heat distribution throughout the thermal array 20. Further, the serpentine shape 76 permits the thermal temperature control element 22 or heating wire 74 to follow the part contours 58, 60, 62. Thus, the thermal temperature control element 22 can follow the various membrane shoulders, which allows for more conformal adhesive activation, particularly when the thermal temperature control element 22 is a heating wire 74. With a heating wire 74, it is advantageous for the wire to be flexible and robust enough for handling, as they are situated within the thickness of the flexible body 16.

The thermal temperature control element 22 is at least partially embedded, or preferably, is fully embedded, within a thickness of the membrane 10. When the thermal temperature control element 22 is the heating wire 74, as shown, it is advantageous for the wire to be embedded in the middle of the thickness of the membrane, which can help avoid hot spots. In the illustrated embodiment, since the heating wire 74 is fully embedded in the thickness of the flexible body 16, it is advantageous to heat the heating wire or thermal temperature control element 22 to a temperature in excess of the adhesive activation temperature. In some embodiments, this temperature may be 20-40% greater than the adhesive activation temperature, but the temperature could depend on various factors such as the thickness of the body 16 and the heat transfer properties of the various materials. With an adhesive activation temperature of about 55° C., the temperature of the thermal temperature control element 22 could be about 65-75° C. In this example embodiment, the flexible body 16 is silicone and the thickness is about 2-2.5 mm, with the heating wire 74 being fully embedded in the middle of the thickness. As mentioned above, it is possible for the thermal temperature control element 22 to cool the part or panel 14, which may be a functional addition to, or a functional alternative to, the heating example provided.

When manufacturing the panel 14, the thermal membrane 10 allows for the panel 14 to be heated and/or cooled while under vacuum. In one embodiment method of manufacture, a multi-layer structure 38 is created by applying an adhesive layer 46, 48 to the interlayer or spacer 44, to the substrate 42, to the skin layer 40, or to some larger or more limited combination thereof. The thermal membrane 10 is then situated over the multi-layer structure 38. The thermal temperature control element 22 creates a warm thermal array 20 which heats the adhesive layer to the adhesive activation temperature, or in excess of the adhesive activation temperature, while the vacuum pump 32 of the vacuum fixture 12 is applying vacuum pressure. The thermal temperature control element 22 or heating wire 74 can be shut off, and the panel 14 can be allowed to cool, while vacuum pressure is still being applied. In some implementations, water cooling is integrated in the method. This conformal adhesive activation method, along with variations thereof using a thermal membrane 10, can provide improved temperature control of the panel 14 during manufacture. This can help prevent potential delamination and provide a more robust part.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A thermal membrane, comprising:
a flexible body;
a part contour in the flexible body; and
a thermal array that includes a thermal temperature control element, wherein the thermal array follows the part contour of the flexible body and the thermal temperature control element is at least partially embedded in the flexible body.

2. The thermal membrane of claim 1, wherein the part contour has a stabilized form that maintains a three-dimensional shape when the thermal membrane is isolated.

3. The thermal membrane of claim 2, wherein the three-dimensional shape is a membrane shoulder configured to conform to a part shoulder of an interior panel of a vehicle.

4. The thermal membrane of claim 3, wherein the thermal temperature control element at least partially follows the membrane shoulder.

5. The thermal membrane of claim 1, wherein the flexible body is made from a silicone-based material or a rubber-based material.

6. The thermal membrane of claim 1, wherein a temperature of the thermal temperature control element is configured to exceed an adhesive activation temperature.

7. The thermal membrane of claim 1, wherein the thermal temperature control element is a heating wire.

8. The thermal membrane of claim 7, wherein the heating wire is arranged in a serpentine shape that includes a plurality of undulations, each undulation having a peak.

9. The thermal membrane of claim 8, wherein each peak is situated outside of an interior part portion of the flexible body.

10. An interior panel for a vehicle, comprising:
a substrate;
a skin layer; and
an adhesive layer, wherein the adhesive layer is activated by the thermal array of the thermal membrane of claim 1.

11. The interior panel of claim 10, wherein the skin layer defines an A-side of the vehicle interior panel, and the flexible body of the heating membrane has a shape that conforms to a shape of the A-side.

12. The interior panel of claim 10, wherein the adhesive layer is a compound adhesive layer comprising adhesive material from an outboard surface of the skin layer and an inboard surface of an interlayer.

13. A method of manufacturing an interior panel for a vehicle, the interior panel having a multi-layer structure with a skin layer, a substrate, an interlayer between the skin layer and the substrate, and an adhesive layer adjacent the interlayer, the method comprising the steps of:
applying the adhesive layer to the interlayer, to the skin layer, or to both the interlayer and the skin layer;
situating a thermal membrane over the multi-layer structure, wherein the thermal membrane comprises a flexible body and a thermal temperature control element that is at least partially embedded in the flexible body; and
heating the thermal temperature control element in the thermal membrane.

14. The method of claim 13, further comprising the step of situating the multi-layer structure over a vacuum fixture, and wherein the heating step takes place while the multi-layer structure is being vacuumed by the vacuum fixture.

15. The method of claim 13, further comprising the step of activating an adhesive material in the adhesive layer by heating the thermal temperature control element to a temperature above an adhesive activation temperature.
